(19) United States
(12) Patent Application Publication
(10) Pub. No.: US 2015/0373455 A1
(43) Pub. Date: Dec. 24, 2015

(54) PRESENTING AND CREATING AUDIOLINKS

(71) Applicant: Thomas Alan Donaldson, Nailsworth (GB)

(72) Inventor: Thomas Alan Donaldson, Nailsworth (GB)

(73) Assignee: AliphCom, San Francisco, CA (US)

(21) Appl. No.: 14/313,895

(22) Filed: Jun. 24, 2014

(51) Int. Cl. H04R 3/12; G10L 17/22

(52) U.S. Cl. CPC H04R 3/12; G10L 17/22; H04R 2430/00

(57) ABSTRACT

Techniques for generating summaries and action items associated with speech are described. Disclosed are techniques for presenting a first audio signal including a portion of a first audio stream at a loudspeaker, identifying data representing an audiolink associated with the first audio stream, and determining data representing a cue and data representing a second audio stream associated with the audiolink. A second audio signal including the cue may be presented, and a third audio signal including a portion of the second audio stream may be presented at the loudspeaker.

### CROSS REFERENCE TO RELATED APPLICATIONS

This application is related to co-pending U.S. patent application Ser. No. 14/289,617, filed May 28, 2014, entitled “SPEECH SUMMARY AND ACTION ITEM GENERATION,” which is incorporated by reference herein in its entirety for all purposes.

### FIELD

Various embodiments relate generally to electrical and electronic hardware, computer software, human-computing interfaces, wired and wireless network communications, telecommunications, data processing, signal processing, natural language processing, wearable devices, and computing devices. More specifically, disclosed are techniques for presenting and creating audiolinks, among other things.

### BACKGROUND

Conventionally, an audio stream (such as a song, a speech, an audio recording, an audio component of a video recording, and the like) is presented sequentially, from one point in the audio stream to a later point in the audio stream, with minimal user interaction or manipulation. User interaction options typically include “Play,” “Stop,” “Pause,” “Forward,” and “Back.” More advanced user interactions include the ability to speed up or slow down the presentation of the audio stream. However, the audio stream is still presented in sequential fashion. A user may move from one audio stream to another by stopping the current stream, manually selecting the other audio stream, and playing the other audio stream.

Thus, what is needed is a solution for presenting and creating audiolinks for an audio stream.

### BRIEF DESCRIPTION OF THE DRAWINGS

Various embodiments or examples (“examples”) are disclosed in the following detailed description and the accompanying drawings:

FIG. 1 illustrates an example of an audiolink manager implemented on a media device, according to some examples;

FIG. 2A illustrates an example of a functional block diagram for an audiolink manager, according to some examples;

FIG. 2B illustrates an example of a functional block diagram for a summary manager coupled to an audiolink manager, according to some examples;

FIG. 3 illustrates an example of a table or list of audiolinks, according to some examples;

FIG. 4 illustrates an example of a sequence of audio signals presented and operations performed by an audiolink manager, according to some examples;

FIG. 5 illustrates another example of a sequence of audio signals presented and operations performed by an audiolink manager, according to some examples;

FIG. 6 illustrates an example of a functional block diagram for creating or modifying an audiolink using an audiolink manager, according to some examples;

FIG. 7A illustrates an example of a sequence of operations for creating or modifying an audiolink using an audiolink manager, according to some examples;

FIG. 7B illustrates an example of a user interface for creating or modifying an audiolink using an audiolink manager, according to some examples;

FIG. 8 illustrates an example of a sequence of audio signals presented and operations performed by an audiolink manager when creating or modifying an audiolink, according to some examples;

FIG. 9 illustrates an example of a flowchart for implementing an audiolink manager; and

FIG. 10 illustrates a computer system suitable for use with an audiolink manager, according to some examples.

### DETAILED DESCRIPTION

Various embodiments or examples may be implemented in numerous ways, including as a system, a process, an apparatus, a user interface, or a series of program instructions on a computer readable medium such as a computer readable storage medium or a computer network where the program instructions are sent over optical, electronic, or wireless communication links. In general, operations of disclosed processes may be performed in an arbitrary order, unless otherwise provided in the claims.

A detailed description of one or more examples is provided below along with accompanying figures. The detailed description is provided in connection with such examples, but is not limited to any particular example. The scope is limited only by the claims and numerous alternatives, modifications, and equivalents are encompassed. Numerous specific details are set forth in the following description in order to provide a thorough understanding. These details are provided for the purpose of example and the described techniques may be practiced according to the claims without some or all of these specific details. For clarity, technical material that is known in the technical fields related to the examples has not been described in detail to avoid unnecessarily obscuring the description.

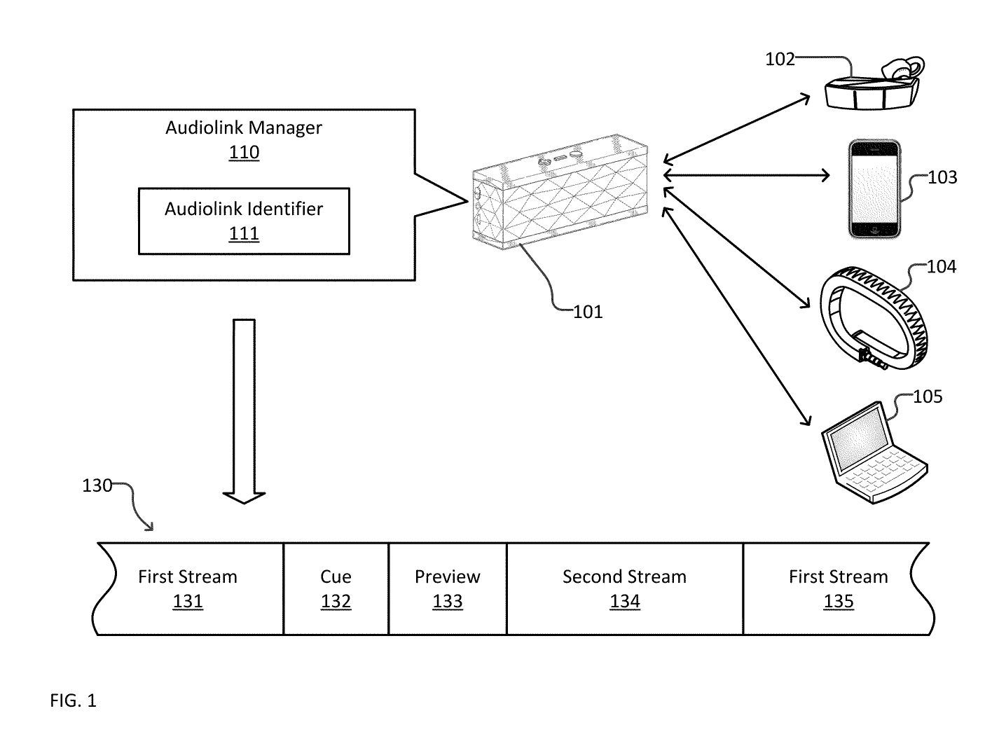

FIG. 1 illustrates an example of an audiolink manager implemented on a media device, according to some examples. As shown, FIG. 1 depicts a media device 101, a headset 102, a smartphone or mobile device 103, a data-capable strapband 104, a laptop 105, an audiolink manager 110, an audiolink identifier 111, and an audio signal 130 including a portion of a first audio stream 131, a cue 132, a preview 133, a portion of a second audio stream 134, and another portion of the first audio stream 135. Audiolink manager 110 may present an audio signal 130 including a portion of a first audio stream 131. The audio signal 130 may be presented at a loudspeaker coupled to media device 101, or at another device such as headset 102, smartphone 103, data-capable strapband 104, laptop 105, or another device. In one implementation, media device 101 may be implemented as a JAMBOX® produced by AliphCom, San Francisco, Calif. Media device 101 may also be another device.

An audio stream may include audio content that is to be presented at a loudspeaker. Examples include a song, a speech, an audiobook, an audio recording, an audio component of a video recording, other media content, and the like. Data representing an audio stream may be presented as it is being delivered by a provider (e.g., a server), presented as it is being recorded or stored, accessed from a local or remote memory in data communication with loudspeaker, stored in a storage drive or removable memory (e.g., DVD, CD, etc.), and the like. Data representing an audio stream may be stored in a variety of formats, including but not limited to mp3, m4p, way, and the like, and may be compressed or uncompressed, or lossy or lossless. As shown, audio stream 131 may be associated with one or more audiolinks. An audiolink may be an element associated with a portion of a first audio stream 131 (e.g., a current or original audio stream) that references or links to a portion of another audio stream or another portion of the first audio stream. An audiolink may point to an audio stream or a specific portion or timestamp of an audio stream. An audiolink may enable a user to interact with the first audio stream 131. A user may follow an audiolink to its associated audio stream 134 (e.g., a different audio stream, another portion of the same audio stream, etc.). When an audiolink is followed, the first audio stream 131 may be automatically paused, and the second audio stream 134 (e.g., a destination or target audio stream) may be automatically selected and presented. After presenting the second audio stream 134, another portion of the first audio stream 135 may be presented, which may resume presentation of the first audio stream at the timestamp at which it was paused. The second audio stream 134 may be statically or dynamically determined. In some examples, an association between an audiolink and an address of a second audio stream 134 may be stored in a memory, and this address may be called every time the audiolink is followed. In other examples, an audiolink may be associated with search terms or parameters as well as an audio library that is stored in or distributed over one or more memories, databases, or servers, or that is accessible over the Internet or another network. A real-time search may be performed by applying those search terms to the audio library in order to determine the second audio stream 134. In other examples, an audiolink may be associated with a plurality of second audio streams, and one of them may be selected and presented. Still, other methods for determining a second audio stream 134 may be used.

As described above, an audiolink may be associated with a first audio stream 131. An audiolink identifier 111 may identify one or more audiolinks associated with a first audio stream 131. An audiolink may be statically or dynamically associated with a first audio stream 131. In some examples, an audiolink may be embedded at a fixed timestamp of a first audio stream 131. When presentation of the first audio stream 131 reaches that timestamp, the audiolink will be presented. In other examples, an audiolink may be associated with an audio or acoustic fingerprint template, or another parameter. When a match or substantial similarity is found between the fingerprint template or parameter and a portion of the first audio stream 131, then the audiolink is presented. Still, other methods for associating the audiolink with a first audio stream 131 may be used.

An audiolink may be associated with a cue 132, which may be used to indicate that an audiolink is available in the first audio stream 131. When a user is notified that an audiolink is available, he may choose to follow the audiolink. The user may follow the link by providing a gesture, command, or other user input. A cue may be a ringtone, such as “ding,” a bell sound, or the like. A cue may include applying an audio effect to the first audio stream 131 as the first audio stream 131 continues to be presented. For example, the first audio stream 131 may be presented with altered acoustic properties (e.g., frequency, amplitude, speed, etc.). The audio effect may cause the first audio stream 131 to be presented in a virtual space or environment that is different from the real one (e.g., being presented from a direction different from the direction of the loudspeaker, being presented in a large room with loud echoes, etc.). The audio effect may implement surround sound, two-dimensional (2D) or three-dimensional (3D) spatial audio, or other technology. Surround sound is a technique that may be used to enrich the sound experience of a user by presenting multiple audio channels from multiple speakers. 2D or 3D spatial audio may be a sound effect produced by the use multiple speakers to virtually place sound sources in 2D or 3D space, including behind, above, or below the user, independent of the real placement of the multiple speakers. In some examples, at least two transducers operating as loudspeakers can generate acoustic signals that can form an impression or a perception at a listener's ears that sounds are coming from audio sources disposed anywhere in a space (e.g., 2D or 3D space) rather than just from the positions of the loudspeakers. In presenting audio effects, different audio channels may be mapped to different speakers.

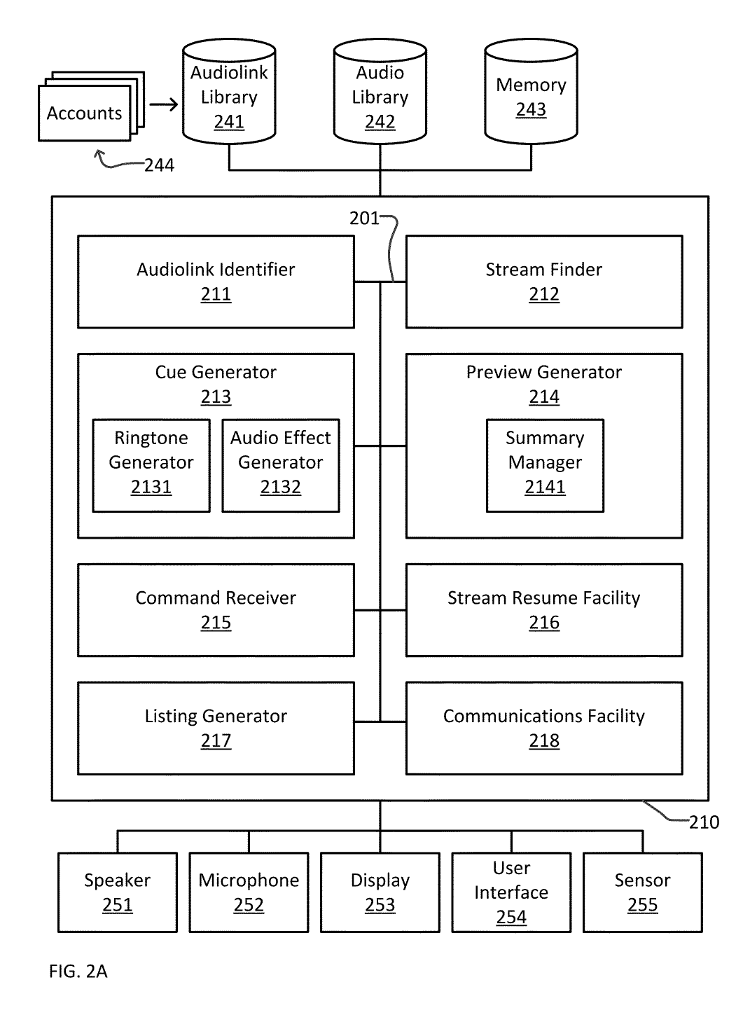

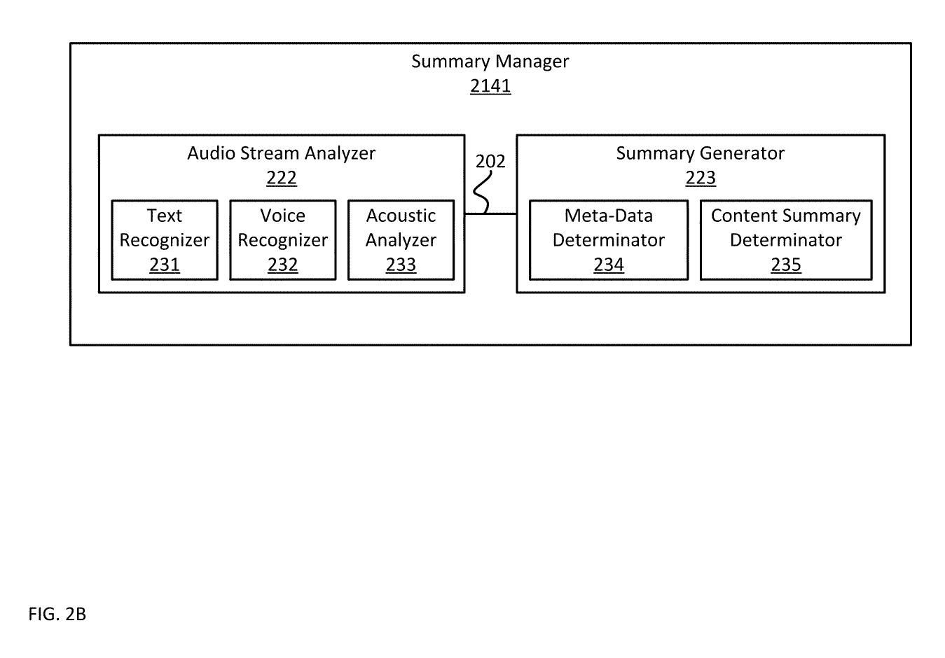

After a cue 132 is provided, a user may provide a response, such as a command to present a preview 133, a command to present a second audio stream 134, a command to continue presenting the first audio stream 131 or 135, or the like. A preview 133 may include an extraction from the second audio stream 134, a summary of the second audio stream 134, one or more keywords or meta-data associated with the second audio stream 134, or the like. A summary (including a keyword and meta-data) may be generated using a summary manager, which is described in co-pending U.S. patent application Ser. No. 14/289,617, filed May 28, 2014, entitled “SPEECH SUMMARY AND ACTION ITEM GENERATION,” which is incorporated by reference herein in its entirety for all purposes. A summary manager may process an audio signal 130 and analyze speech and acoustic properties therein. A speech recognizer, a speaker recognizer, an acoustic analyzer, or other facilities or modules may be used to analyze the audio signal 130, and to determine one or more keywords, audio fingerprints, acoustic properties, or other parameters. The keywords, audio fingerprints, acoustic properties, and other parameters may be used interactively to generate a summary (see FIG. 2B). In some examples, a preview 133 may be presented after the first audio stream 131 is paused. In other examples, a preview 133 may be mixed with the first audio stream 131, and the mixed audio signal may be presented. The audio mixing may include applying audio effects to the preview 133, the first audio stream 131, or both. For example, the mixed audio signal may be configured to present the preview 133 in the background (e.g., from a far distance, in a direction behind the user, etc.) and the first audio stream 131 in the foreground (e.g., from a close distance, in a direction in front of the user, etc.).

As shown, for example, audiolink manager 110 may be implemented on media device 101 and may present audio signal 130 at one or more loudspeakers coupled to media device 101. A portion of a first audio stream 131 may be presented. An audiolink may be identified by audiolink identifier 111, and a cue 132 may be presented. A preview 133 may be presented automatically after the cue 132, or may be presented after receiving a user command. A portion of a second audio stream 134 may be presented automatically after the preview 133 (or in other examples automatically after the cue 132), or after receiving a user command. Finally, another portion of the first audio stream 135, which may be a continuation of the first portion of the first audio stream 131, may be presented. Media device 101 may be in data communication with headset 102, smartphone 103, band 104, laptop 105, or other devices. These other devices may be used by audiolink manager 110 to receive user commands. Media device may access an audio library directly, or may access an audio library through other devices. The audio library may store the first audio stream 131 or 135, the second audio stream 134, or other audio streams, or may store pointers, references, or addresses of audio streams.

FIG. 2A illustrates an example of a functional block diagram for an audiolink manager, according to some examples. As shown, FIG. 2 depicts an audiolink manager 210, a bus 201, an audiolink identification facility 211, a stream finder facility 212, a cue generation facility 213, a preview generation facility 214, a command receiving facility 215, a stream resume facility 216, a listing generation facility 217, and a communications facility 218. Cue generator 213 may include a ringtone generation facility 2131, an audio effect generation facility 2132, or other facilities. Preview generator 214 may include a summary manager 2141 or other facilities. Audiolink manager 210 may be coupled to an audiolink library 241, an audio stream library 242, and a memory 243. Elements 241-243 may be stored on one memory or database, or distributed across multiple memories or databases, and the memories or databases may be local or remote. Audiolink library 241 may be associated with one or more user accounts 244. Audiolink manager 210 may also be coupled to a loudspeaker 251, a microphone 252, a display 253, a user interface 254, and a sensor 255. As used herein, “facility” refers to any, some, or all of the features and structures that may be used to implement a given set of functions, according to some embodiments. Elements 211-218 may be integrated with audiolink manager 210 (as shown) or may be remote from or distributed from audiolink manager 210. Elements 241-243 and elements 251-255 may be local to or remote from audiolink manager 210. For example, audiolink manager 210, elements 241-243, and elements 251-255 may be implemented on a media device or other device, or they may be remote from or distributed across one or more devices. Elements 241-243, 251-255, and/or 211-217 may exchange data with audiolink manager 210 using wired or wireless communications through communications facility 218. Communications facility 218 may include a wireless radio, control circuit or logic, antenna, transceiver, receiver, transmitter, resistors, diodes, transistors, or other elements that are used to transmit and receive data from other devices. In some examples, communications facility 218 may be implemented to provide a “wired” data communication capability such as an analog or digital attachment, plug, jack, or the like to allow for data to be transferred. In other examples, communications facility 218 may be implemented to provide a wireless data communication capability to transmit digitally-encoded data across one or more frequencies using various types of data communication protocols, such as Bluetooth, ZigBee, Wi-Fi, 3G, 4G, without limitation. Communications facility 218 may be used to receive data from other devices (e.g., a headset, a smartphone, a data-capable strapband, a laptop, etc.).

Audiolink identifier 211 may be configured to identify one or more audiolinks associated with one or more audio streams. Audiolink identifier 211 may monitor an audio stream to identify one or more audiolinks. In some examples, audiolink identifier 211 may process, scan, or filter an audio stream, while the audio stream is being presented or not being presented, to determine a match with an audiolink indicator associated with an audiolink. For example, an audiolink may be identified as a first audio stream is being presented. As the audio stream is processed to be presented at a loudspeaker, it is also processed to determine whether it matches an audiolink indicator. As another example, an audiolink may be identified while the stream is not being presented (e.g., before or after presenting the audio stream). A subset or all of the audiolinks associated with an audio stream may be identified prior to presentation of the audio stream, and audiolink manager 210 may present a plurality of the audiolinks as a list (e.g., a table of contents).

An audiolink may be identified using a static indicator (e.g., a timestamp of the first audio stream) or dynamic indicator (e.g., a match with a fingerprint template or other parameter). A static audiolink indicator may be identified while the audio stream is or is not being presented. For example, an audiolink indicator may indicate it is available at or associated with a certain timestamp (e.g., 0:57) of a first audio stream. As a first audio stream is presented, audiolink manager 210 may monitor or keep track of the timestamp of the first audio stream. Audiolink identifier 211 may compare the timestamp that is to be presented with a timestamp specified by the audiolink indicator, and may determine a substantial match (e.g., a match within a range or tolerance). Audiolink identifier 211 may identify the audiolink and prompt audiolink manager 210 to continue processing the audiolink (e.g., determining and presenting a cue, a preview, a second audio stream, etc.). As another example, before or after presentation of the audio stream, audiolink identifier 211 may scan or process the audio stream to identify one or more audiolinks, which may be embedded or associated with the audio stream using one or more timestamps. Audiolink identifier 211 may prompt audiolink manager 210 to provide a list of a subset or all of the audiolinks, along with associated timestamps, names, or other information, which may serve as a listing of audiolinks (e.g., a table of contents). The listing of audiolinks may be presented at a loudspeaker, a display, and/or another user interface.

A dynamic audiolink indicator may serve to identify an audiolink that is not embedded or fixed in an audio stream. For example, a dynamic indicator may be an audio fingerprint or another parameter associated with an audio stream. Examples include a frequency, amplitude, or speed or tempo of an audio stream, or a word spoken in an audio stream, or a voice of a speaker or singer in the audio stream, or a sound of a musical instrument in the audio stream, or the like. An audio fingerprint may be a template or a set of unique characteristics of a voice, sound, or audio signal (e.g., average zero crossing rate, frequency spectrum, variance in frequencies, tempo, average flatness, prominent tones, frequency spikes, etc.). An audio fingerprint may include a specific sequence of unique characteristics, or may include an average, sum, or other general representation of unique characteristics. Where an audio signal includes voice (e.g., speech, singing, etc.), an audio fingerprint may be used as or transformed into a vocal fingerprint, which may be used to distinguish one person's voice from another's. A vocal fingerprint may be used to identify an identity of the person providing the voice, and may also be used to authenticate the person providing the voice. For example, an audio fingerprint may include a specific sequence of tones (e.g., do-re-mi). As another example, an audio fingerprint may include characteristics that identify a genre of music (e.g., rock and roll). As another example, an audio fingerprint may include characteristics of the voice of a certain person. Audiolink identifier 211 may process the audio stream, which may be performed while the audio stream is or is not being presented. In some examples, the audio stream may be processed using a Fourier transform, which transforms signals between the time domain and the frequency domain. In some examples, the audio stream may be transformed or represented as a mel-frequency cepstrum (MFC) using mel-frequency cepstral coefficients (MFCC). In the MFC, the frequency bands are equally spaced on the mel scale, which is an approximation of the response of the human auditory system. The MFC may be used in speech recognition, speaker recognition, acoustic property analysis, or other signal processing algorithms. In some examples, the audio stream may be transformed or represented as a spectrogram, which may be a representation of the spectrum of frequencies in an audio or other signal as it varies with time or another variable. The MFC or another transformation or spectrogram of the audio stream may then be processed or analyzed using image processing, which may be used to identify one or more audio fingerprints or parameters associated with the audio stream. In some examples, the audio signal may also be processed or pre-processed for noise cancellation, normalization, and the like. Audiolink identifier 211 may compare the audio fingerprint or parameter associated with the audiolink and the audio fingerprint or parameter associated with a first audio stream. Audiolink identifier 211 may determine a match if there is a substantial similarity or a match within a range or tolerance. A match may indicate that an audiolink is found. If the first audio stream is being presented, then audiolink manager 210 may present a cue, preview, or second audio stream, which may notify the user that an audiolink is available. Audiolink manager 210 may also include this audiolink in a listing of audiolinks (e.g., a table of contents) that may be presented before or after the presentation of the first audio stream.

An audiolink, and in some examples its audiolink indicator and other associated information (e.g., cue, destination or target audio stream, preview, etc.), may be stored in audiolink library 241. For example, an audiolink library 241 may contain one or more audio fingerprints that may be used as one or more audiolink indicators. Audiolink identifier 211 may access audiolink library 241 to retrieve an audio fingerprint associated with an audiolink, and compare it with an audiolink fingerprint determined or derived from a current audio stream. In some examples, an audiolink may be stored as part of a file having data representing an audio stream. In some examples, audiolink library 241 and audio stream library 242 may be merged as one library. For example, the song “Amazing Grace” may be embedded with audiolinks. A file having data representing “Amazing Grace” may be associated or tagged with data representing audiolinks, which specify audiolink indicators or timestamps. Audiolink identifier 211 may identify an audiolink by scanning an audio stream and determining whether an audiolink is embedded. In some examples, an audiolink may be associated with a user account 244. For example, a first account may have an audiolink specifying an audiolink at timestamp 0:57 of the song “Amazing Grace,” and a second account may have another audiolink indicated by an audio fingerprint. When the song “Amazing Grace” is presented and the first account is being used or logged in, audiolink identifier 211 may use the one or more audiolinks associated with the first account, and may thus identify an audiolink at timestamp 0:57 of the song “Amazing Grace.” When the song “Amazing Grace” is being presented and the second account is being used or logged in, audiolink identifier 211 may identify an audiolink if it finds a match between the associated audio fingerprint and the song “Amazing Grace.”

Stream finder 212 may be configured to identify a second audio stream (e.g., a destination or target audio stream) associated with an audiolink. The second audio stream may be a destination or target audio stream which may be presented when an audiolink is followed. Whether the second audio stream is presented may be dependent on a user command. The second audio stream may be stored in audio stream library 242. Stream finder 212 may find or access the second audio stream from audio stream library 242. Audio stream library 242 may be stored as one or multiple memories, databases, servers, or storage devices. In some examples, audio stream library 242 may include data representing audiolinks, and may overlap or merge with audiolink library 241.

An audiolink may be statically or dynamically associated with a second audio stream (e.g., destination audio stream). In some examples, the destination audio stream is fixed. For example, the audiolink may be stored in a table that specifies the destination audio stream, the audiolink may be tagged with the destination audio stream, or other static associations may be used. The destination audio stream may be specified by an address, a file name, a pointer, or another identifier. The destination audio stream may include a specific timestamp of an audio stream to be presented. For example, the destination audio stream may be the song “Amazing Grace” at timestamp 0:57. Upon following the audiolink, presentation of “Amazing Grace” would begin substantially at the 0:57 timestamp. The destination audio stream may be a different audio stream (e.g., different song, audio recording, media content, audio file, etc.) from the current audio stream, or may be another portion (e.g., another timestamp) of the current audio stream. In other examples, the destination audio stream may be determined in real-time, or it may vary based on the audio stream, the audiolink, or the like. For example, an audiolink may specify a search parameter to be used for finding the destination audio stream, and may specify a scope within which to search (e.g., an audio stream library 242). For example, the search parameter may include an audio fingerprint or other parameter, such as a word in an audio stream, a speaker, singer, musical instrument or other source of sound in an audio stream, a frequency spectrum or characteristic of an audio stream, and the like. The search parameter of an audiolink may be related to the audiolink indicator of the audiolink. For example, an audiolink indicator may specify a speaker of an audio stream (e.g., identify the audiolink when Ronald Reagan speaks in a first audio stream). Then the search parameter may include this speaker (e.g., find a destination audio stream that includes the voice of Ronald Reagan). The audiolink, when followed, may bring the user to the destination audio stream, which may provide more information or speeches related to the same speaker (e.g., another speech of Ronald Reagan may be presented). Stream finder 212 may compare the search parameter with one or more audio streams stored in audio stream library 242. Stream finder 212 may determine that an audio stream that has a characteristic matching the search parameter is the destination audio stream. Stream finder 212 may determine more than one audio stream matches the search parameter, and select one of the plurality of audio streams randomly or based on other factors (e.g., user preferences (which may be stored in account 244), sensor data received from sensor 255, time of day, etc.). The search parameter may vary as a function of these other factors as well. For example, a search parameter may include an audio fingerprint as well as a tempo. The audio fingerprint may be associated with a genre (e.g., rock and roll). The tempo may vary based on the time of day (e.g., faster during day and slower during night). As another example, a search parameter may be associated with physiological data, which may be detected by sensor 255. For example, a faster heart rate may correspond with searching for a song in a major key, while a slower heart rate may correspond with searching for a song in a minor key. Further, the audio streams stored within audio stream library 242 may vary independent of audiolink manager 210. For example, audio stream library 242 may be a website or service accessed over the Internet and maintained by a third party (e.g., YouTube of San Bruno, Calif., Pandora of Oakland, Calif., Spotify of New York, N.Y., etc.). A destination audio stream that is dynamically determined may or may not be the same audio stream (e.g., song, speech, audiobook, audio or video file, etc.) each time the associated audiolink is identified or followed. In some examples, the second audio stream may include a preview or summary of another audio stream. Upon following an audiolink, a user may have the option of presenting the preview version or full version, or both, of the other audio stream. A preview may be generated by preview generator 214 and/or a summary manager 2141 (e.g., discussed below and in FIG. 2B).

Cue generator 213 may be configured to generate a cue associated with an audiolink, and may include a ringtone generator 2131, an audio effect generator 2132, and other facilities, modules, or applications. A cue may serve as a signal to a user that an audiolink is available. For example, an audiolink may be identified while a first audio signal is being presented. A cue may interrupt, overlay, or be mixed with the first audio signal to notify the user that the audiolink is present. The audiolink may be followed automatically or upon user command. Ringtone generator 2131 may generate a ringtone or other specific tone or sound to be used as a cue. For example, the cue may be a “ding,” “ring,” series of sounds (e.g., ascending scale), or another sound (e.g., a cat's purr, a recording of a person's voice, sound of machinery, sound of natural phenomena, etc.). Audio effect generator 2132 may apply an audio effect on the first audio stream as it is being presented, which may signify a cue or a presence of an audiolink. An audio effect may include applying reverberation, echoing effects, attenuating certain frequencies (e.g., high, low, etc.), speeding up or slowing down the audio stream, adding or reducing noise, changing the frequency or amplitude, changing the phase of audio signals presented from different sources, and the like. An audio effect may create an impression that the audio stream is originating from a changed source or environment. For example, an audio stream having an audio effect may sound as if it is being presented in a large concert hall, a room with an opened door, an outdoor environment, a crowded place, and the like. An audio effect may include presenting different audio channels at multiple loudspeakers, which may be placed in different locations. An audio effect may include presenting surround sound, 2D or 3D audio, and the like. For example, a first audio stream may be presented at two loudspeakers coupled to a media device, which may be placed substantially directly in front of a user. The first audio stream may be presented as originating from the two loudspeakers, that is, in an area in front of the user. When an audiolink is identified or detected, a cue may be provided. In one example, the cue may use 3D audio to virtually place the source of the first audio stream to be to the right of the user. In another example, the cue may include mixing the first audio stream with another audio stream (e.g., a destination audio stream associated with the audiolink, a preview of the destination audio stream, etc.). The first audio stream may continue to be presented from an area in front of the user, while the other audio stream may be presented from a virtual source behind the user. The user may be able to listen to both streams at the same time, with the second audio stream originating from a less primary location. Still, other cues, ringtones, and audio effects may be used.

In some examples, a cue may be visual, haptic, or involve other sensory perceptions. In some examples, one cue may involve several types of sensory perceptions. For example, a cue may include generating a ringtone at a media device and generating a vibration at a wearable device. A wearable device may be worn on or around an arm, leg, ear, or other bodily appendage or feature, or may be portable in a user's hand, pocket, bag or other carrying case. As an example, a wearable device may be a headset, smartphone, data-capable strapband, or laptop (e.g., see FIG. 1). Other wearable devices such as a watch, data-capable eyewear, tablet, or other computing device may be used. For example, a cue may include generating text or graphics at a display. The text may notify the user that a cue is available, present a summary of the destination audio stream associated with the audiolink, a name or label of the audiolink, and the like.

Preview generator 214 may be configured to generate a preview of a destination or target audio stream associated with an audiolink. A preview may include an extraction of the destination audio stream. For example, a preview may be a certain duration of the destination audio stream, or a number of sentences spoken in the destination audio stream, or the like. As another example, a preview may be a summary of the destination audio stream, which may be generated by summary manager 2141. A summary may include meta-data or characteristics about the audio stream, such as the people present, the type or genre, the mood, the duration, the date and time of creation or last modification, and the like. A summary may also include a content summary of the audio stream. A content summary may provide a brief or concise account of the text or lyrics included in the audio stream, a description of the content of the audio stream, a keyword or key sentence extracted from the audio stream, paraphrased sentences or paragraphs that summarize the audio stream, bullet-form points about the audio stream, and the like. A summary may provide a general notion or overview about an audio stream, or the main points associated with an audio stream, without having to present the entire audio stream. Summary manager 2141 is further discussed below (e.g., see FIG. 2B).

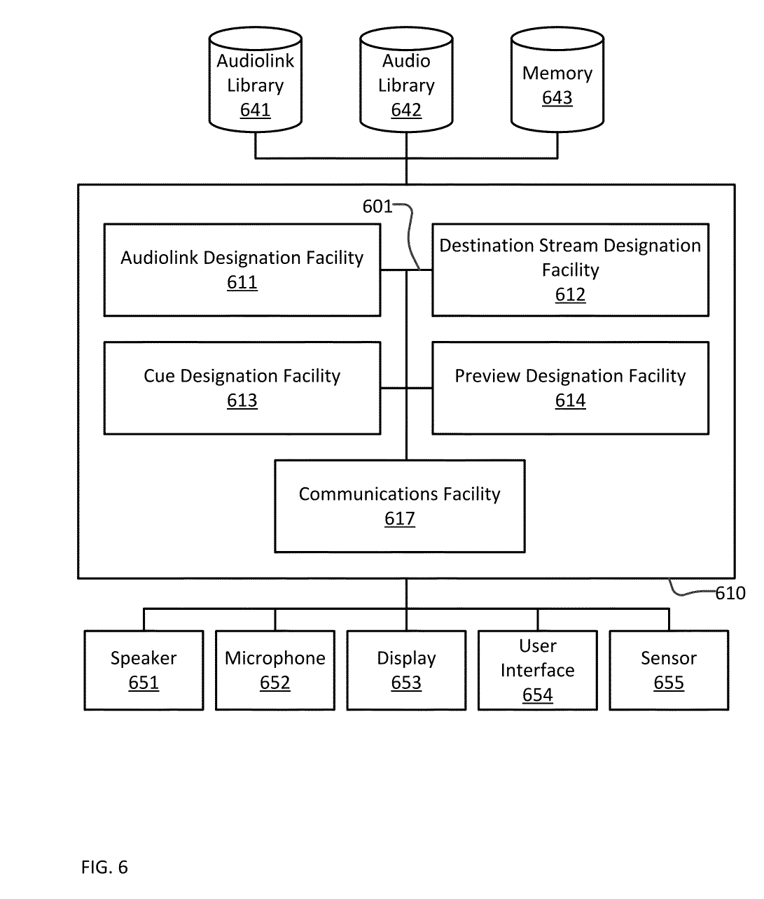

Command receiver 215 may be configured to receive a command or control signal from user interface 254. User interface 254 may be configured to exchange data between audiolink manager 210 and a user. User interface 254 may include one or more input-and-output devices, such as loudspeaker 251, microphone 252, display 253 (e.g., LED, LCD, or other), sensor 255, keyboard, mouse, monitor, cursor, touch-sensitive display or screen, vibration generator or motor, and the like. For example, command receiver 215 may receive a voice command from microphone 252. After a cue is presented, a voice command may prompt audiolink manager 210 to follow or not to follow an audiolink, to present or not present a preview or a second audio stream, and the like. As another example, a user may enter via a keyboard or mouse, with or without the assistance of a display 253, a command to follow or not to follow an audiolink. As another example, a gesture or motion detected by sensor 255 (e.g., motion sensor, accelerometer, gyroscope, etc.) may serve as a command to follow or not to follow an audiolink. For example, a cue may be presented using 3D audio techniques as a ringtone originating from a virtual source located in a certain direction relative to the user (e.g., to the rear left of a user). A gesture to follow the audiolink may be a motion associated with that direction (e.g., turning the user's head in the rear left direction). This motion may be detected by a motion sensor physically coupled to a headset worn on a user's ear, and the headset may be in data communication with audiolink manager 210. Command receiver 215 may perform motion matching to determine whether a gesture has been detected by sensor 255. In some examples, an audiolink may be followed based on other sensor data. For example, sensor 255 may include other types of sensors, such as a thermometer, a light sensor, a location sensor (e.g., a Global Positioning System (GPS) receiver), an altimeter, a pedometer, a heart or pulse rate monitor, a respiration rate monitor, and the like. For example, an audiolink may be automatically followed if a heart rate is above a certain threshold. User interface 254 may also be used to receive user input in creating, modifying, or storing audiolinks, which is further discussed below (e.g., see FIGS. 6-8). Speaker 251 may be configured to present audio signals, including audio streams, cues, previews, and the like. Still, user interface 254 may be used for other purposes.

Stream resume facility 216 may be configured to resume presentation of a current or original audio stream after it has been interrupted by an audiolink. The interruption may include a pause of the current audio stream, a mixing of the current audio stream with another audio stream, an audio effect being applied on the current audio stream, a presentation of a preview or another audio stream, or other user interaction with the current audio stream. Stream resume facility 216 may store a timestamp or other indicator of the current audio stream, indicating a portion of the current audio stream that was interrupted. For example, while a first audio stream is presented, at a certain timestamp (e.g., 1:04), a cue is presented. A user command is then received to follow the audiolink, and a second audio stream is presented. Presentation of the second audio stream may then be paused or terminated, which may be because the presentation of the second audio stream is complete, or because another user command has been received to stop the second audio stream, or for another reason. Stream resume facility 216 may then present the first audio stream, starting substantially at the stored timestamp (e.g., 1:04). Stream resume facility 216 may resume presentation of the first audio stream automatically after presentation of the second audio stream has been terminated, or it may resume presentation of the first audio stream after receiving a user command. As another example, stream resume facility 216 may store the timestamp associated with the beginning of the presentation of a cue, a preview, a second audio stream, and the like, and a user may resume presentation of the first audio stream at any of those points. In some examples, stream resume facility 216 may resume presentation of the first audio stream within a certain range from the timestamp indicating an interruption. For example, while the interruption occurred at 1:04, stream resume facility 216 may resume presentation of the first audio stream at 0:59, five seconds before the stored timestamp. This may allow the user to be reminded of the last portion of the first audio stream before it was interrupted. Stream resume facility 216 may store the timestamp or other indicator at memory 243. Memory 243 may be local to or remote from audiolink manager 210, and may include one or multiple memories, databases, servers, storage devices, and the like.

Listing generator 217 may be configured to generate a listing of audiolinks found in an audio stream (e.g., a table of contents, an index, and the like). The listing of audiolinks may include a label or name associated with each audiolink. For example, an audiolink at timestamp 0:57 may have a label entitled “0:57.” As another example, an audiolink identified using an audio fingerprint that indicates the genre rock and roll may have a label entitled “rock and roll.” A label of an audiolink may be entered manually by a user, or automatically generated based on the audiolink indicator or other information. The listing of audiolinks may provide a list of labels, which may be provided as an audio signal, visually, or using user interface 254. The listing of audiolinks may provide other data related to the audiolinks. For example, it may provide the timestamp of the audiolink. For example, an audiolink named “Ronald Reagan” may be the voice of Ronald Reagan. Audiolink identifier 211 may determine that the voice of Ronald Reagan is presented at timestamp 1:27-3:33. The listing of audiolinks may provide the label and the timestamp, for example, “Ronald Reagan-1:27 to 3:33.” The listing of audiolinks may also provide information about the destination or target audio stream, the cue, the preview, and the like. The listing of audiolinks may be presented while the audio stream is or is not being presented. For example, a user may desire to listen to a listing of audiolinks prior to listening to the entire audio stream. A user may desire to jump directly to an audiolink from the listing of audiolinks, without first initiating a presentation of the audio stream.

FIG. 2B illustrates an example of a functional block diagram for a summary manager coupled to an audiolink manager, according to some examples. As shown, FIG. 2 depicts a summary manager 2141, which may include a bus 202, an audio stream analyzer 222, a summary generator 223, and other facilities, modules, or applications. Summary manager 2141 may be implemented as part of audiolink manager 210 (e.g., see FIG. 2A), or it may be remote from audiolink manager 210. A summary manager and the generation of summaries of audio streams is further described in co-pending U.S. patent application Ser. No. 14/289,617, filed May 28, 2014, entitled “SPEECH SUMMARY AND ACTION ITEM GENERATION,” which is incorporated by reference herein in its entirety for all purposes.

Audio stream analyzer 222 may be configured to process and analyze an audio stream. Audio stream analyzer 222 may analyze a MFC representation, spectrogram, or other transformation of the audio stream, which may be produced or generated by an audiolink identifier (e.g., see audiolink identifier 211 of FIG. 2A). Audio stream analyzer 222 may employ text recognizer 231, voice recognizer 232, acoustic analyzer 233, or other facilities, applications, or modules to analyze one or more parameters of an audio stream. Text recognizer 231 may be configured to recognize words spoken in an audio stream, which may include words being stated in a speech or conversation, being sung in the lyrics of a song, and the like. Text recognizer 231 may translate or convert spoken words into text. Acoustic modeling, language modeling, hidden Markov models, neural networks, statistically-based algorithms, and other methods may be used by text recognizer 231. Text recognizer 231 may be speaker-independent or speaker-dependent. In speaker-dependent systems, text recognizer 231 may be trained to and learn an individual person's voice, and may then adjust or fine-tune algorithms to recognize that person's spoken words.

Voice recognizer 232 may be configured to recognize one or more vocal or acoustic fingerprints in an audio stream. A person's voice may be substantially unique due to the shape of his mouth and the way the mouth moves. A vocal fingerprint may be a type of audio fingerprint that may be used to distinguish one person's voice from another's. Voice recognizer 232 may analyze a voice in an audio stream for a plurality of characteristics, and produce a fingerprint or template for that voice. Voice recognizer 232 may determine the number of vocal fingerprints in an audio stream, and may determine which vocal fingerprint is speaking a specific word or sentence within the audio stream. Further, a vocal fingerprint may be used to identify or authenticate an identity of the speaker. For example, a vocal fingerprint of a person's voice may be previously recorded and stored, and may be stored along with the person's biographical or other information (e.g., name, job title, gender, age, etc.). The person's vocal fingerprint may be compared to a vocal fingerprint generated from an audio stream. If a match is found, then voice recognizer 232 may determine that this person's voice is included in the audio stream.

Acoustic analyzer 233 may be configured to process, analyze, and determine acoustic properties of an audio stream. Acoustic properties may include an amplitude, frequency, rhythm, and the like. For example, an audio stream of a speech may include a monotonous tone, while an audio stream of a song may include a wide range of frequencies. Acoustic analyzer 233 may analyze the acoustic properties of each word, sentence, sound, paragraph, phrase, or section of an audio stream, or may analyze the acoustic properties of an audio stream as a whole.

Summary generator 223 may be configured to generate a summary of the audio stream using the information determined by audio stream analyzer 222. Summary generator 223 may employ a meta-data determinator 234, a content summary determinator 235, or other facilities or applications. Meta-data determinator 234 may be configured to determine a set of meta-data, or one or more characteristics, associated with an audio stream. Meta-data may include the number of people present or participating in the audio stream, the identities or roles of those people, the type of audio stream (e.g., lecture, discussion, song, etc.), the mood of the audio stream (e.g., highly stimulating, sad, etc.), the duration of the audio stream, and the like. Meta-data may be determined based on the words, vocal fingerprints, speakers, acoustic properties, or other parameters determined by audio stream analyzer 222. For example, audio stream analyzer 222 may determine that an audio stream includes two vocal fingerprints. The two vocal fingerprints alternate, wherein a first vocal fingerprint has a short duration, followed by a second vocal fingerprint with a longer duration. The first vocal fingerprint repeatedly begins sentences with question words (e.g., “Who,” “What,” “Where,” “When,” “Why,” “How,” etc.) and ends sentences in higher frequencies. Meta-data determinator 224 may determine that the audio stream type is an interview or a question-and-answer session. Still other meta-data may be determined.

Content summary determinator 235 may be configured to generate a content summary of the audio stream. A content summary may include a keyword, key sentences, paraphrased sentences of main points, bullet-point phrases, and the like. A content summary may provide a brief account of the speech session, which may enable a user to understand a context, main point, or significant aspect of the audio stream without having to listen to the entire audio stream or a substantial portion of the audio stream. A content summary may be a set of words, shorter than the audio stream itself, that includes the main points or important aspects of the audio stream. A content summary may be a key or dramatic portion of a song or other media content (e.g., a chorus, a bridge, a climax, etc.). A content summary may be determined based on the words, vocal fingerprints, speakers, acoustic properties, or other parameters determined by audio stream analyzer 222. For example, based on word counts, and a comparison to the frequency that the words are used in the general English language, one or more keywords may be identified. For example, while words such as “the” and “and” may be the words most spoken in an audio stream, their usage may be insignificant compared to how often they are used in the general English language. For example, a sequence of words repeated in a similar tone may indicate that it is a chorus of a song. A keyword may be one or more words. For example, terms such as “paper cut,” “apple sauce,” “mobile phone,” and the like, having multiple words may be one keyword. As another example, based on vocal fingerprints, a voice that dominates an audio stream may be identified, and that voice may be identified as a voice of a key speaker. A keyword may be identified based on whether it is spoken by a key speaker. As another example, a keyword may be identified based on acoustic properties or other parameters associated with the audio stream. In some examples, a content summary may include a list of keywords. In some examples, sentences around a keyword may be extracted from the audio stream, and presented in a content summary. The number of sentences to be extracted may depend on the length of the summary desired by the user. In some examples, sentences from the audio stream may be paraphrased, or new sentences may be generated, to include or give context to keywords.

As described above, a summary generated by summary manager 2141 may be used as a preview. After an audiolink associated with a second audio signal is identified, a summary of the second audio signal may be presented as a preview. A user may listen to the preview before deciding whether to listen to the second audio signal. In other examples, other types of previews may be used by an audiolink manager.

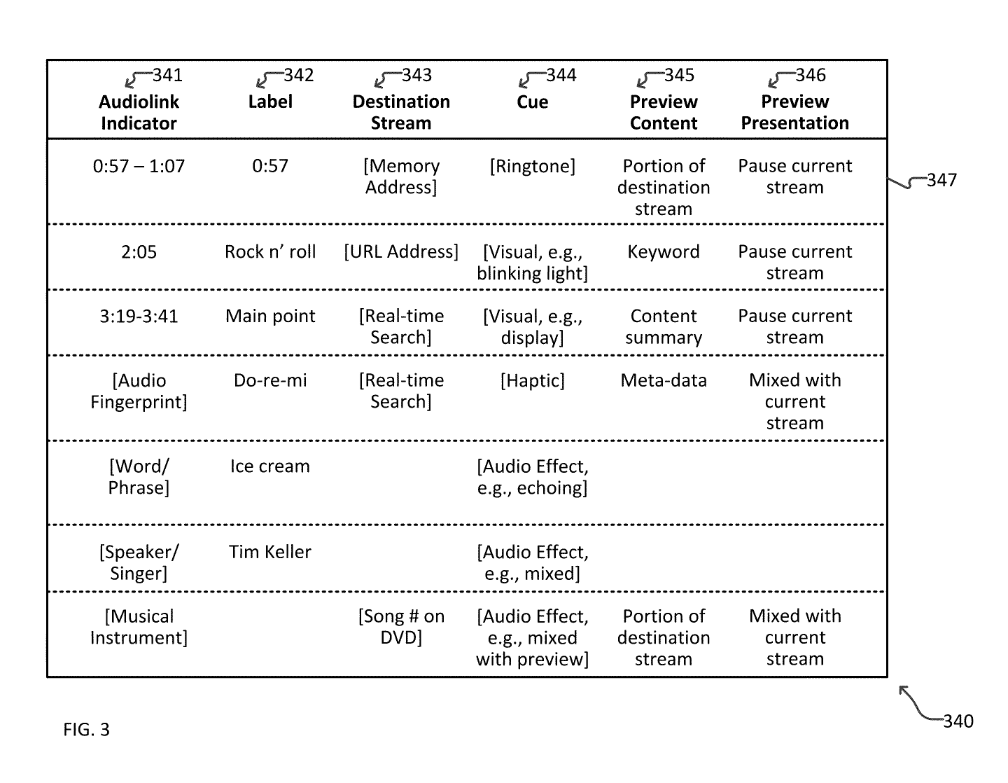

FIG. 3 illustrates an example of a table or list of audiolinks, according to some examples. As shown, FIG. 3 depicts a table of audiolinks 340, headings of the table including audiolink indicator 341, label 342, destination stream 343, cue 344, preview content 345, and preview presentation 346. In some examples, entries of table 340 may be associated with an audio stream. For example, the first row 347 of the table depicts an example of an audiolink identified using a timestamp. Thus, an audiolink is available at this timestamp (e.g., 0:57-1:07) of the associated audio stream. In other examples, entries of table 340 may be associated with a user account. For example, an audiolink may be identified using an audio fingerprint. If the user account is being logged in, an audiolink may be identified for every audio stream that has a match with the associated audio fingerprint. In other examples, an audiolink may be associated with a service, an application, or a database, which may be provided by a third party. For example, while presenting audio streams from a provider such as YouTube, every mention of “YouTube” in an audio stream may be an audiolink, which may link to another audio stream providing an overview of the company YouTube. In some examples, storage and organization methods other than a table may be used. For example, an audiolink may be stored as a tag to an audio stream. Audiolinks may also be stored across several tables, or a different table may be used for each audio stream and/or each user account.

As shown, for example, audiolink indicator 341 may be used to identify an audiolink in an audio stream. An audiolink indicator 341 may be a timestamp (or a timestamp range), an audio fingerprint, or another parameter (e.g., a word, a speaker, a musical instrument, etc.). Other parameters may also be used. For example, for a timestamp range, a cue may be presented any time within that range, or may be presented for the duration of that range. An audiolink indicator may be specifically tied to a portion of an audio stream (e.g., a timestamp). An audiolink indicator may also be used to dynamically identify audiolinks in one or more audio streams. For example, an audiolink identifier may compare an audio fingerprint associated with an audiolink to a plurality of audio streams, and each match would correspond to an audiolink. The same audio fingerprint may result in a plurality of audiolinks in a plurality of audio streams.

As shown, for example, label 342 may be used to provide a name or user-friendly identification to an audiolink. The name may be presented as part of a listing of audiolinks, or as part of a cue, preview, second audio stream, or the like. The name may be manually input by a user. For example, referring to the second row of table 340, a user may create an audiolink at timestamp 2:05 because he decides that this portion of a current audio stream is playing rock and roll music. He may then manually label this audiolink as “rock and roll.” The name may also be automatically generated. For example, referring to row 347, the name may be the timestamp (or beginning of the timestamp range) of the audiolink indicator.

As shown, for example, destination audio stream 343 may be an identification, file, or data representing an audio stream that is referenced by an audiolink. In some examples, more than one destination audio stream may be referenced by an audiolink. A stream finder may determine which of the multiple destination audio streams to present. A destination audio stream may be fixed. For example, it may specify a memory address or URL address of where the audio stream is located. A destination audio stream may be dynamic or determined in real-time. For example, one or more search parameters and audio stream libraries may be specified or determined in real-time. In some examples, the search parameter may be related to the audiolink indicator or label. For example, referring to the fourth row of table 340, an audiolink with an audiolink indicator being a sequence of sounds (e.g., “do-re-mi”) may have a search parameter being the same sequence of sounds. The search parameter may vary based on a variety of factors, which may be determined by sensor data. For example, a search parameter may be “do-re-mi” in normal operation, but it may be changed based on a user state. For example, a sensor physically coupled to a data-capable strapband worn by a user may detect that a user is fatigued, and the search parameter may be an audio fingerprint indicating a relaxing song. An audio stream library may also be specified as part of destination stream 343. For example, an audio stream library may be a user's private library (e.g., her storage device), or it may include any audio stream available on the Internet. A search engine such as Google of Mountain View, Calif., may be employed to search the audio stream library.

As shown, for example, a cue 344 may be used to provide notification of the presence or availability of an audiolink during presentation of an audio stream. It may include an audio, visual, or haptic signal, or a combination of the above, or another type of signal. It may include an audio effect being applied to one or more audio streams. For example, it may include presentation of the current audio stream with an altered frequency, amplitude, or tempo. For example, it may include presentation of a mixed audio signal including the current audio stream and the destination audio stream. For example, it may include using 3D audio techniques to place one sound or audio stream from a virtual source. In some examples, the cue 344 may be merged with the preview content 345 and preview presentation 346. For example, referring to the last row of table 340, a cue may be the mixing of a preview with the current audio stream. Thus, the cue and preview are simultaneously presented. In some examples, after presentation of a cue, a preview or a second audio stream may be presented, and this may be determined based on a user command or input. In some examples, a preview or second audio stream may not be presented, and presentation of the current audio stream may continue or be resumed.

As shown, for example, a preview content 345 and a preview presentation 346 may be used to provide a preview of destination audio stream 343. In some examples, preview content 345 may include an extraction or portion of a destination audio stream. In some examples, preview content 345 may include a summary of a destination audio stream. A summary may include meta-data, a content summary, a keyword, and the like, and may be generated by a summary manager. Preview presentation 346 may refer to the presentation of the preview, such as its interaction with the presentation of the current audio stream and/or the destination audio stream. For example, the current audio stream may be paused, and then preview may be presented. As another example, the current audio stream and the preview may be mixed, and both may be presented simultaneously. An audio effect, such as 3D audio, may be applied, to help the user listen to both the current audio stream and the preview simultaneously. For example, the current audio stream may be presented in the foreground, while the preview is presented in the background (e.g., from a virtual source behind the user). In some examples, the preview 345 may be presented after the cue 344, or it may be presented as the cue 344. In some examples, after presentation of the preview, the destination audio stream may be presented. The presentation of the destination audio stream may be prompted by a user command. For example, the user command may be a motion associated with a direction of a virtual source from which a preview is originating (e.g., turning a user's head towards the back while a preview is presented from a rear virtual source). In some examples, after presentation of the preview, presentation of the current audio stream may be resumed.

In some examples, an audiolink may not have data or parameters for every heading 341-346. For example, referring to the fifth and sixth rows of table 340, a destination audio stream is not indicated for these audiolinks. These audiolinks may bring special attention to certain portions of a current audio stream, but may not necessarily link to a destination audio stream. For example, when the words “ice cream” are spoken in an audio stream, an audio effect may be presented, which may serve to “underline” these words in the audio stream. As another example, referring to the last row of table 340, an audiolink may not have a label. In one example, it may be presented as part of a listing of audiolinks using other information associated with the audiolink (e.g., the audiolink indicator, the destination audio stream, etc.). in another example, this audiolink may not be presented as part of a listing of audiolinks. Still other headings or formats for storing or organizing audiolinks may be used.

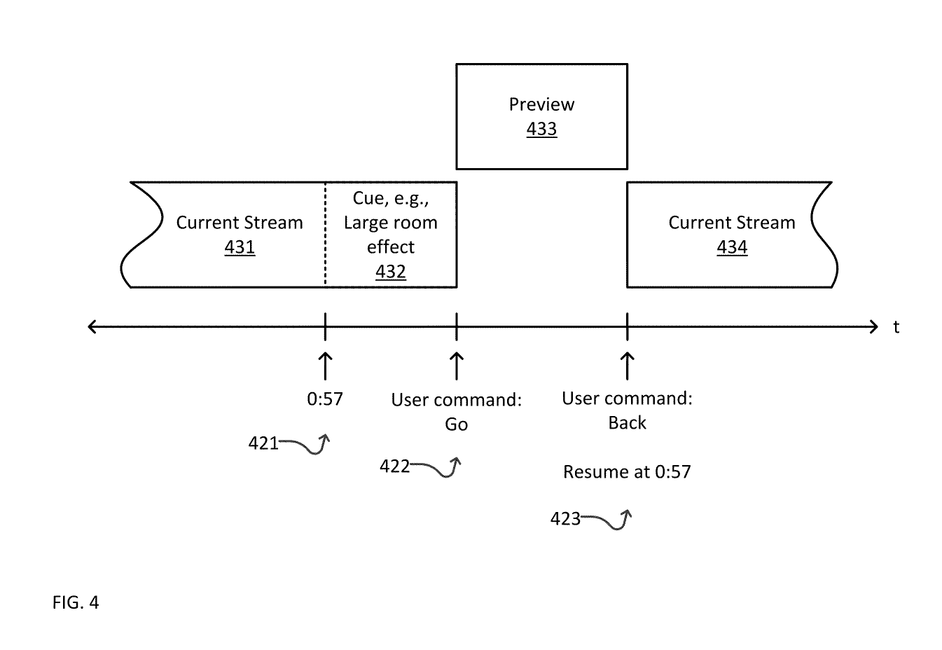

FIG. 4 illustrates an example of a sequence of audio signals presented and operations performed by an audiolink manager, according to some examples. As shown, FIG. 4 depicts a first portion of a current audio stream 431, a cue 432, a preview 433, and a second portion of the current audio stream 434, as well as a time associated with a timestamp 421, and times associated with user interactions 422-423. In one example, a first portion of a current audio stream 431 is being presented. An audiolink identified by the timestamp “0:57” is detected at time 421. Cue 432 is then presented. The cue may be, for example, the current audio stream 431 having an audio effect. The effect may cause the current audio stream 431 to be presented as if it were being played in a large room. A user command “Go” or a command to follow the audiolink may be received at time 422. As shown, for example, presentation of the current audio stream 431 may be terminated, and presentation of preview 433 may begin. Other examples may be used (e.g., stream 431 may be missed with preview 433, a destination audio stream rather than preview 433 may be presented, etc.). A user command “Back” may be received at time 423. For example, after listening to preview 433, a user may determine that she does not desire to listen to the destination audio stream. Presentation of another portion of current audio stream 434 may begin. The another portion of the current audio stream 434 may be a resumption of the presentation of the first portion of the current audio stream 431. For example, presentation of the current audio stream may begin at timestamp “0:57.” Still, other implementations may be used.

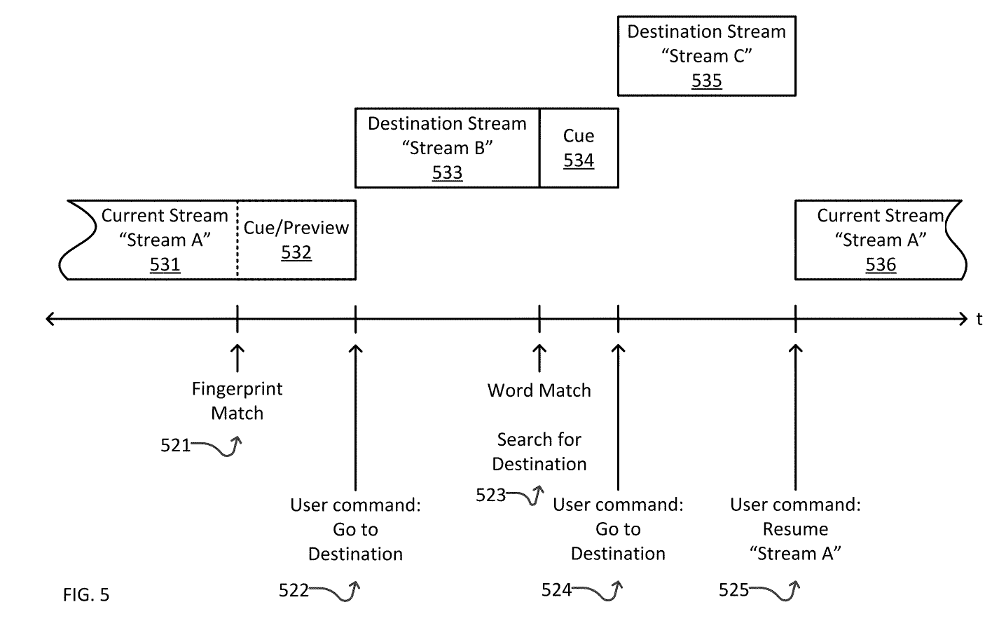

FIG. 5 illustrates another example of a sequence of audio signals presented and operations performed by an audiolink manager, according to some examples. As shown, FIG. 5 depicts a first portion of a current audio stream (labeled “Stream A”) 531, a preview serving as a cue 532, a portion of a first destination audio stream (labeled “Stream B”) 533, another cue 534, a portion of a second destination audio stream (labeled “Stream C”) 535, and a second portion of the current audio stream (labeled “Stream A”) 536. FIG. 5 also depicts times associated with identification of audiolinks 521 and 523, as well as times associated with user interactions 522, 524, and 525. In one example, while “Stream A” 531 is being presented, a match is found between “Stream A” 531 and an audio fingerprint associated with an audiolink at time 521. A cue 532 is then presented. For example, as shown, cue 532 is a mixed signal including “Stream A” 531 and a preview of “Stream B” 533. A user command to go to the destination audio stream, “Stream B,” is received at time 522. Presentation of “Stream A” is terminated, and presentation of “Stream B” 533 begins. In other examples, not shown, rather than terminating presentation of “Stream A,” “Stream A” may be mixed with “Stream B,” and the mixed audio signal may be presented. Since the user has indicated that she desires to go to the destination audio stream, “Stream B” may be presented in the foreground while “Stream A” is presented in the background. Another audiolink may be identified in “Stream B” at time 523. This audiolink may have an audiolink indicator associated with a word, and this word may be found in “Stream B” at time 523. This audiolink may have a destination audio stream that is dynamically identified by one or more search parameters. At or around time 523, a search for the destination audio stream using the search parameters may be performed. A cue 534 may be presented. At time 524, a user command to go to the destination audio stream may be received. This command may refer to the destination audio stream with respect to the audiolink found in “Stream B.” Thus, presentation of “Stream C” 535 may begin. At time 525, a user command to resume “Stream A” may be received. Then another portion of “Stream A” 536 may be presented. The second portion of “Stream A” 536 may or may not include a time period of overlap with the first portion of “Stream A” 531. The second portion of “Stream A” 536 continues or resumes the presentation of “Stream A” from the time it was interrupted, which may be at or around time 521 or time 522. In some examples, not shown, during presentation of “Stream C” 535, a user command to resume “Stream B” (rather than “Stream A”) may be received. Thus, a user may jump or browse through a plurality of audiolinks identified in a plurality of audio streams.

FIG. 6 illustrates an example of a functional block diagram for creating or modifying an audiolink using an audiolink manager, according to some examples. As shown, FIG. 6 depicts an audiolink manager 610, a bus 601, an audiolink designation facility 611, a destination stream designation facility 612, a cue designation facility 613, a preview designation facility 614, and a communications facility 617. Audiolink manager 610 may be coupled to an audiolink library 641, an audio stream library 642, a memory 643, a loudspeaker 651, a microphone 652, a display 653, a user interface 654, and a sensor 655. Like-numbered and like-named elements 641-643 and 651-655 function similarly or have similar structure to elements 241-243 and 251-255 in FIG. 2. Communications facility 617 may function similarly or have similar structure to communications facility 217 in FIG. 2.

Audiolink designation facility 611 may be configured to receive user input to designate an audiolink indicator of an audiolink. This user input may be received while an audio stream is or is not being presented. For example, during presentation of an audio stream, a user may create an audiolink at a certain timestamp of the audio stream, and this timestamp may become the audiolink indicator of this audiolink. As another example, while an audio stream is not being presented, a user may specify an audiolink indicator at a certain timestamp of the audio stream. For example, a user may input using a keyboard that the timestamp “0:57” of the song “Amazing Grace” corresponds to an audiolink. A user may designate a dynamic audiolink indicator by entering an audio fingerprint or other parameter. For example, a user may reference a portion of an audio stream that is stored in a memory. Audiolink designation facility 611 may retrieve this portion of the audio stream, and analyze it to determine one or more audio fingerprints or parameters. The audio fingerprints or parameters may be used as an audiolink indicator. As another example, a user may play a portion of an audio stream, which may be received by microphone 652. Audiolink designation facility 611 may analyze the audio signal received by microphone 652 to determine one or more audio fingerprints or other parameters.

Destination stream designation facility 612 may be configured to receive user input to designate a destination or target audio stream associated with an audiolink. In some examples, a user may specify an address or name of a destination audio stream. In other examples, a user may specify search parameters and an audio stream library to be used to search for a destination audio stream. In other examples, an audiolink may not be associated with any designation audio stream. Cue designation facility 613 may be configured to receive user input to designate a cue associated with an audiolink. The user may specify a type of cue to be used (e.g., ringtone, audio effect, visual, haptic, etc.). Preview designation facility 614 may be configured to receive user input to designate a type of preview content and preview presentation associated with an audiolink. The user may specify that the preview is to be an extraction of the destination audio stream, and may specify which portion to extract. The user may specify that a summary is to be generated, and the type of summary to be generated. An existing audiolink may be similarly modified by a user using elements 611-614. Communications facility 217 may be used to receive user input, which may be entered through a local or remote user interface 654.

The information associated with an audiolink entered by the user may be stored in audiolink library 641. An audiolink may be associated with a user account, and may be private to a user. An audiolink created by a user may also be shared with other users. Default or predetermined audiolinks created by a media content provider, audio stream provider, or other third party, may also be accessible by a plurality of users, e.g., via a server. In some examples, audiolink library 641 and audio stream library 642 may be one library or storage unit. An audiolink may be created such that it is embedded or stored with an audio stream. Thus, when data representing an audio stream is retrieved from audio stream library 642, this data includes data representing one or more audiolinks associated with the audio stream. Still, other methods for creating and modifying an audiolink may be used.

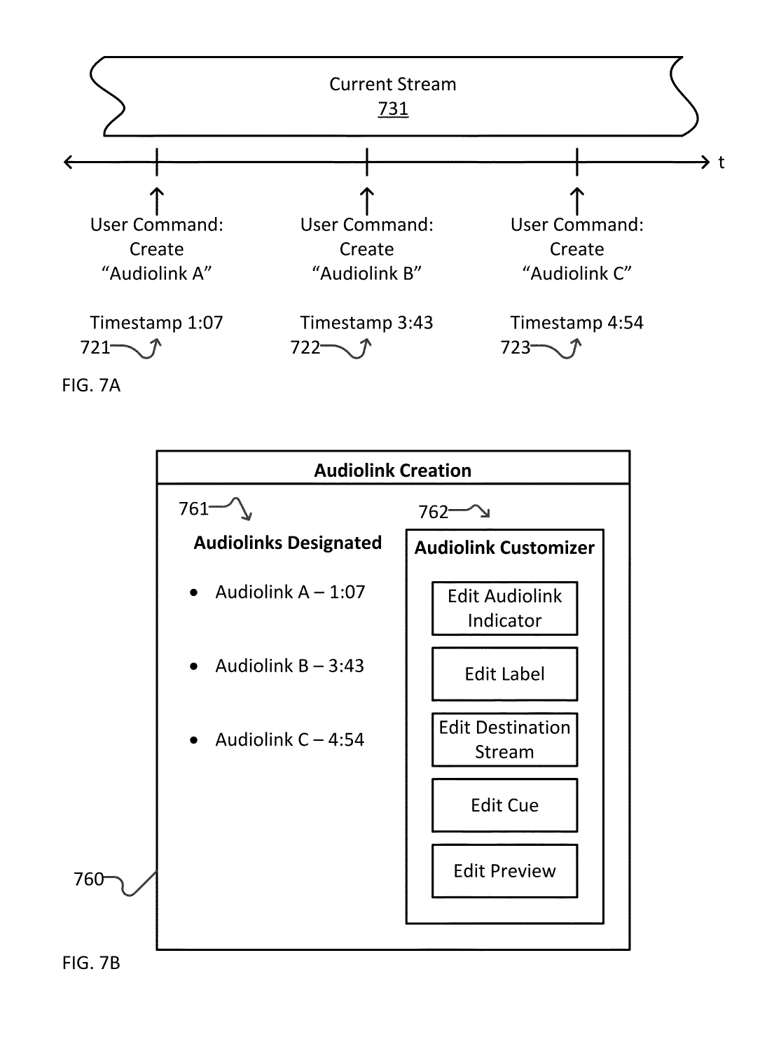

FIG. 7A illustrates an example of a sequence of operations for creating or modifying an audiolink using an audiolink manager, and FIG. 7B illustrates an example of a user interface for creating or modifying an audiolink using an audiolink manager, according to some examples. As shown, FIG. 7A depicts a current audio stream 731, and times associated with user commands to create audiolinks 721-723. FIG. 7B depicts a user interface 760 which may be presented to a user after receiving the user commands at times 721-723, a list of audiolinks that were created 761, and buttons or options for customizing the audiolinks 762.

In some examples, one or more audiolinks are created while an audio stream is being presented, and the presentation of the audio stream is not interrupted during the creation of the audiolinks. For example, as current stream 731 is presented, user commands to create “Audiolink A,” “Audiolink B,” and “Audiolink C” are received at times 721-723, respectively. These may correspond to timestamps 1:07, 3:43, and 4:54 of the current audio stream, respectively. These audiolinks, using these timestamps as audiolink indicators, may be stored. Current stream 731 may continue to be presented uninterrupted. At a later time (e.g., at the end of the presentation of current stream 731), a user interface 760 may be presented at a display. User interface 760 may include a list of audiolinks that were designated 761, including the audiolink indicators. To facilitate the user in distinguishing the audiolinks presented in list 761, the portion of the audio stream 731 associated with each audiolink may be presented at a loudspeaker when each audiolink is clicked or selected. Audiolink customizer 762 may be used to customize a subset or all of the audiolinks in list 761. For example, the user may edit or modify the audiolink indicator, the label, the destination stream, the cue, the preview, and the like. In other examples, customization of audiolinks may be performed using audio signals and voice commands. Still, other methods of creating and modifying audiolinks may be used.

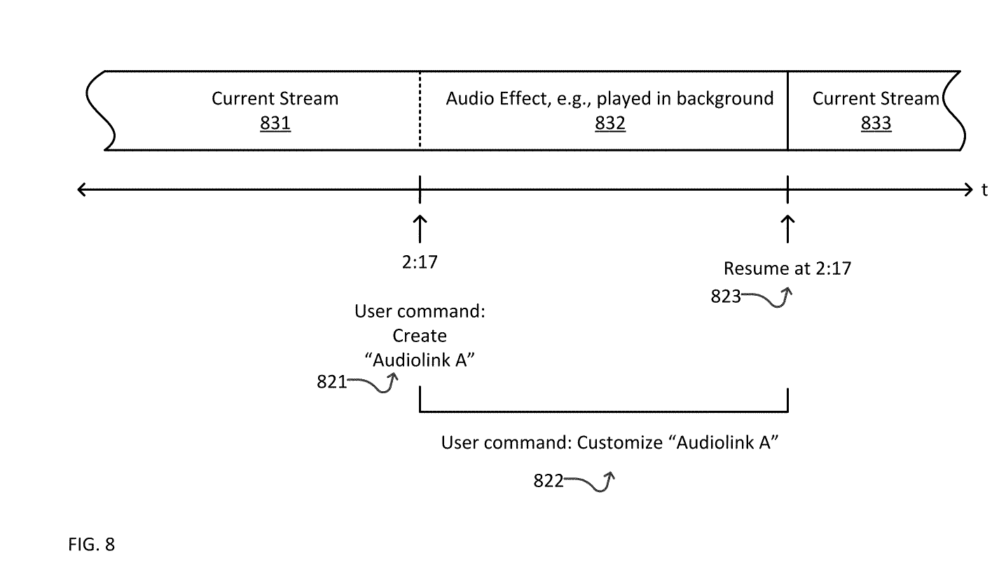

FIG. 8 illustrates an example of a sequence of audio signals presented and operations performed by an audiolink manager when creating or modifying an audiolink, according to some examples. As shown, FIG. 8 depicts a first portion of a current audio stream 831, another portion of the current audio stream having an audio effect 832, and the another portion of the current audio stream 833. FIG. 8 also depicts times associated with user interactions 821-823. In some examples, presentation of the current audio stream 831 may be interrupted, or may be presented with an audio effect or mixed with another audio stream, while one or more audiolinks are created. For example, while a first portion of an audio stream 831 is presented, at time 821, a user command to create “Audiolink A” is received, and this corresponds to timestamp “2:17” of the audio stream. Presentation of current stream 831 may be interrupted as user input to customize “Audiolink A” is received at time period 822. The interruption may include an audio effect being applied on the current stream 832. For example, to enable the user to better concentrate on customizing “Audiolink A,” the audio effect may be to present the current stream in a background (e.g., from a virtual direction behind the user, in a lower amplitude or volume, etc.). In some examples (not shown), presentation of current stream 831 may be paused or terminated during customization of “Audiolink A.” The customization of “Audiolink A” may include inputting data specifying or modifying a cue, preview, destination audio stream, and the like. The data may be input using a display, a keyboard, a button, audio signals, voice commands, and the like. At time 823, customization of “Audiolink A” may be complete. Presentation of the current stream may begin back at the timestamp at which the current stream was interrupted, e.g. “2:17.” Thus, presentation of the current stream may be resumed substantially at the time at which it was interrupted. This may allow audiolinks to be created as the audio stream is being presented, while automatically replaying portions of the audio stream that were played while the user was entering commands to create or customizer an audiolink. Still, other methods of creating and modifying audiolinks may be used.

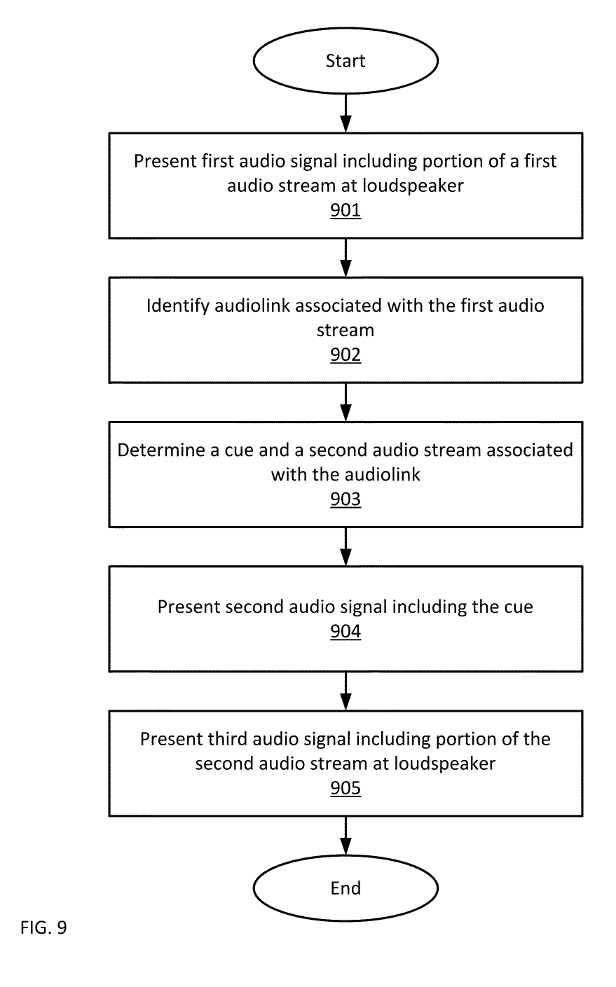

FIG. 9 illustrates an example of a flowchart for implementing an audiolink manager. At 901, a first audio signal including a portion of a first audio stream may be presented at a loudspeaker. At 902, an audiolink associated with the first audio stream may be identified. In some examples, the first audio stream is monitored while a portion of the first audio stream is being presented, and a match is determined between the portion of the first audio stream and an audiolink indicator associated with the audiolink. The audiolink indicator may specify a timestamp, an audio fingerprint, or another parameter or condition, which is compared with the first audio stream. In some examples, the audiolink may be identified while the first audio stream is not being presented. At 903, data representing a cue and data representing a second audio stream associated with the audiolink are determined. The second audio stream associated with the audiolink may be a destination or target audio stream, a preview thereof, or the like. The second audio stream may be determined by searching an audio stream library using a search parameter associated with the audiolink. The cue associated with the audiolink may include a ringtone, or an audio effect applied to the first audio stream, the second audio stream, or another audio stream. In one example, the cue may include a mixing of the first audio stream and a second audio stream (e.g., a preview of a destination audio stream associated with the audiolink). An audio effect, such as 3D audio, may be applied to the mixed signal. For example, the first audio stream may be presented from a virtual source substantially in front of a user, while the second audio stream may be presented from another virtual source substantially behind the user. At 904, a second audio signal including the cue may be presented. At 905, a third audio signal including a portion of the second audio stream may be presented at the loudspeaker. The second audio signal and the third audio signal may be presented sequentially, simultaneously, as a mixed signal, and the like. In some examples, a fourth audio signal including a preview associated with the second audio stream may also be presented. Still, other implementations may be used.

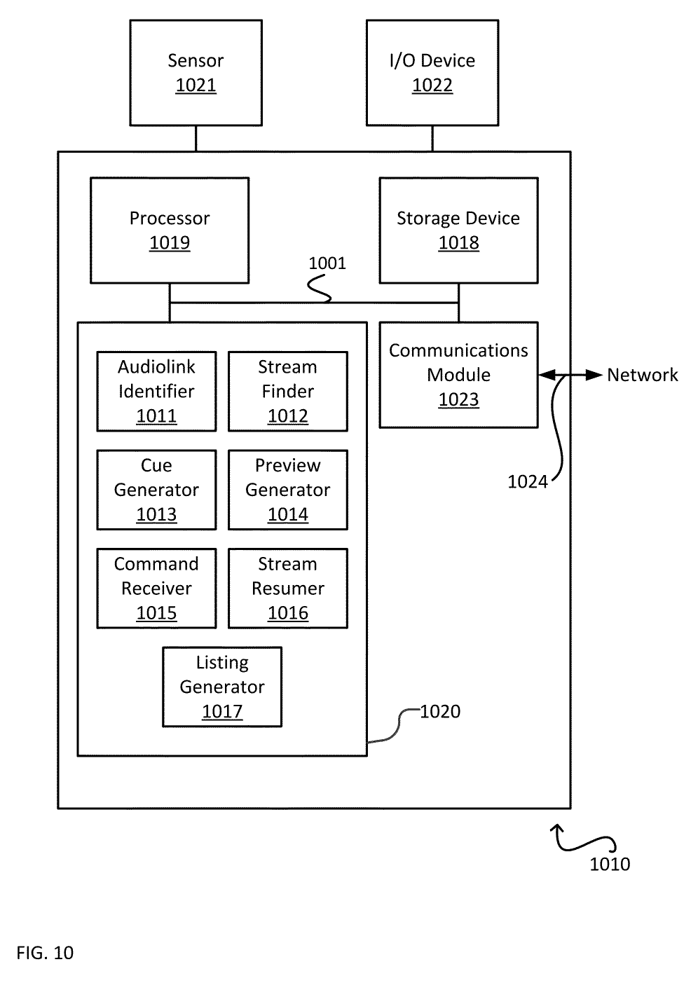

FIG. 10 illustrates a computer system suitable for use with an audiolink manager, according to some examples. In some examples, computing platform 1010 may be used to implement computer programs, applications, methods, processes, algorithms, or other software to perform the above-described techniques. Computing platform 1010 includes a bus 1001 or other communication mechanism for communicating information, which interconnects subsystems and devices, such as processor 1019, system memory 1020 (e.g., RAM, etc.), storage device 1018 (e.g., ROM, etc.), a communications module 1023 (e.g., an Ethernet or wireless controller, a Bluetooth controller, etc.) to facilitate communications via a port on communication link 1024 to communicate, for example, with a computing device, including mobile computing and/or communication devices with processors. Processor 1019 can be implemented with one or more central processing units (“CPUs”), such as those manufactured by Intel® Corporation, or one or more virtual processors, as well as any combination of CPUs and virtual processors. Computing platform 1010 exchanges data representing inputs and outputs via input-and-output devices 1022, including, but not limited to, keyboards, mice, audio inputs (e.g., speech-to-text devices), speakers, microphones, user interfaces, displays, monitors, cursors, touch-sensitive displays, LCD or LED displays, and other I/O-related devices. An interface is not limited to a touch-sensitive screen and can be any graphic user interface, any auditory interface, any haptic interface, any combination thereof, and the like. Computing platform 1010 may also receive sensor data from sensor 1021, including a heart rate sensor, a respiration sensor, an accelerometer, a motion sensor, a galvanic skin response (GSR) sensor, a bioimpedance sensor, a GPS receiver, and the like.

According to some examples, computing platform 1010 performs specific operations by processor 1019 executing one or more sequences of one or more instructions stored in system memory 1020, and computing platform 1010 can be implemented in a client-server arrangement, peer-to-peer arrangement, or as any mobile computing device, including smart phones and the like. Such instructions or data may be read into system memory 1020 from another computer readable medium, such as storage device 1018. In some examples, hard-wired circuitry may be used in place of or in combination with software instructions for implementation. Instructions may be embedded in software or firmware. The term “computer readable medium” refers to any tangible medium that participates in providing instructions to processor 1019 for execution. Such a medium may take many forms, including but not limited to, non-volatile media and volatile media. Non-volatile media includes, for example, optical or magnetic disks and the like. Volatile media includes dynamic memory, such as system memory 1020.

Common forms of computer readable media includes, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, or any other medium from which a computer can read. Instructions may further be transmitted or received using a transmission medium. The term “transmission medium” may include any tangible or intangible medium that is capable of storing, encoding or carrying instructions for execution by the machine, and includes digital or analog communications signals or other intangible medium to facilitate communication of such instructions. Transmission media includes coaxial cables, copper wire, and fiber optics, including wires that comprise bus 1001 for transmitting a computer data signal.

In some examples, execution of the sequences of instructions may be performed by computing platform 1010. According to some examples, computing platform 1010 can be coupled by communication link 1024 (e.g., a wired network, such as LAN, PSTN, or any wireless network) to any other processor to perform the sequence of instructions in coordination with (or asynchronous to) one another. Computing platform 1010 may transmit and receive messages, data, and instructions, including program code (e.g., application code) through communication link 1024 and communication interface 1023. Received program code may be executed by processor 1019 as it is received, and/or stored in memory 1020 or other non-volatile storage for later execution.

In the example shown, system memory 1020 can include various modules that include executable instructions to implement functionalities described herein. In the example shown, system memory 1020 includes an audiolink identification module 1011, a stream finding module 1012, a cue generation module 1013, a preview generation module 1014, a command receiving module 1015, a stream resume module 1016, and a listing generation module 1017.

Although the foregoing examples have been described in some detail for purposes of clarity of understanding, the above-described inventive techniques are not limited to the details provided. There are many alternative ways of implementing the above-described invention techniques. The disclosed examples are illustrative and not restrictive.

What is claimed:

1. A method, comprising:
presenting a first audio signal including a portion of a first audio stream at a loudspeaker;
identifying data representing an audiolink associated with the first audio stream;
determining data representing a cue and data representing a second audio stream associated with the audiolink;
presenting a second audio signal including the cue; and
presenting a third audio signal including a portion of the second audio stream at the loudspeaker.

2. The method of claim 1, further comprising:
monitoring the first audio stream while the portion of the first audio stream is being presented; and
determining a match between the portion of the first audio stream and an audiolink indicator associated with the audiolink.

3. The method of claim 1, further comprising:
searching in an audio stream library using a search parameter associated with the audiolink to determine the second audio stream.

4. The method of claim 1, further comprising:
recognizing a first word associated with the first audio stream; and
determining a match between the first word and a second word associated with the audiolink.

5. The method of claim 4, further comprising:
identifying the second audio stream using at least one of the first word and the second word.

6. The method of claim 1, further comprising:
comparing a first audio fingerprint associated with the first audio stream with a second audio fingerprint associated with the audiolink.

7. The method of claim 6, further comprising:
searching an audio stream library comprising a plurality of audio streams using at least one of the first audio fingerprint and the second audio fingerprint;
determining a match between a third audio fingerprint associated with one of the plurality of audio streams and the at least one of the first audio fingerprint and the second audio fingerprint; and
identifying the one of the plurality of audio streams as the second audio stream.

8. The method of claim 1, wherein the presenting the second audio signal including the cue comprises:
applying an audio effect on the first audio signal including the portion of the first audio stream.

9. The method of claim 1, further comprising:
generating data representing a preview associated with the second audio stream; and
presenting a fourth audio signal including the preview.

10. The method of claim 9, further comprising:
determining one or more words associated with the second audio stream;
determining one or more audio fingerprints associated with the second audio stream;
identifying a keyword associated with the second audio stream using the one or more words and the one or more audio fingerprints; and
generating the preview using the keyword.

11. The method of claim 9, further comprising:
mixing the first audio signal including the portion of the first audio stream with the fourth audio signal including the preview to form a mixed audio signal; and
presenting the mixed audio signal.

12. The method of claim 11, wherein the mixed audio signal is configured to present the fourth audio signal from a virtual source located in a direction relative to the user.

13. The method of claim 12, further comprising:
receiving motion data indicating a motion associated with the direction, the motion data configured to initiate the generating the audio signal comprising the portion of the destination audio stream.

14. The method of claim 1, further comprising:
storing a timestamp of the first audio stream substantially simultaneously with the generating the third audio signal including the portion of the second audio stream;
presenting a fourth audio signal including another portion of the first audio stream after the presenting the third audio signal including the portion of the second audio stream, the another portion of the first audio stream beginning substantially at the timestamp of the first audio stream.

15. The method of claim 1, further comprising:
identifying data representing a plurality of audiolinks associated with the first audio stream; and
presenting a fourth audio signal including a plurality of labels associated with the plurality of audiolinks.

16. The method of claim 1, further comprising:
receiving a first control signal from a user interface while the portion of the first audio stream is being presented;
storing a timestamp of the first audio stream substantially simultaneously with the receiving the first control signal;
receiving a second control signal configured to designate the second audio stream;
associating the timestamp and the second audio stream with the audiolink; and
presenting a fourth audio signal including another portion of the first audio stream after the receiving the second control signal, the another portion of the first audio stream beginning substantially at the timestamp of the first audio stream.

17. The method of claim 16, further comprising:
presenting a fifth audio signal while the second control signal is being received, the fifth audio signal including the another portion of the first audio stream having an audio effect.

18. A system, comprising:
a processor configured to identify data representing an audiolink associated with a first audio stream, and to determine data representing a cue and data representing a second audio stream associated with the audiolink; and
a loudspeaker configured to present a first audio signal including a portion of the first audio stream, to present a second audio signal including the cue, and to present a third audio signal including a portion of the second audio stream.

19. The system of claim 18, wherein the processor is further configured to monitor the first audio stream while the portion of the first audio stream is being presented, and to determine a match between the portion of the first audio stream and an audiolink indicator associated with the audiolink.

20. The system of claim 18, wherein the processor is further configured to search an audio stream library comprising a plurality of audio streams using a search parameter associated with the audiolink, to determine a match between one of the plurality of audio streams and the search parameter; and to identify the one of the plurality of audio streams as the second audio stream.
